(19) United States
(12) Patent Application Publication
(10) Pub. No.: US 2008/0187379 A1
(43) Pub. Date: Aug. 7, 2008

(54) WASTE TONER COLLECTING DEVICE AND IMAGE FORMING APPARATUS HAVING THE SAME

(75) Inventor: Hyung Hyu HWANG, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/970,668

(22) Filed: Jan. 8, 2008

(30) Foreign Application Priority Data
Feb. 2, 2007 (KR) 2007-11040

(51) Int. Cl. G03G 21/12

(52) U.S. Cl. 399/360

(57) ABSTRACT

A waste toner collecting device and an image forming apparatus having the same include a photosensitive body on which an electrostatic latent image is formed, a developing unit which supplies a toner to the photosensitive body to form a visible image, a transfer unit which transfers the visible image formed on the photosensitive body onto a printing medium, and a waste toner collecting device which collects waste toners removed from the photosensitive body and not being transferred onto the printing medium. The waste toner collecting device includes a housing which has a collecting space to accommodate the waste toners, a waste toner distribution plate which is shakably mounted in the collecting space to receive the waste toners introduced into the collecting space and evenly disperse the waste toners in the collecting space, and a shaking device which shakes the waste toner distribution plate. Accordingly, since the waste toners are not concentrated on a specific portion in the collecting space and evenly dispersed in the overall collecting space, a waste toner collecting efficiency of the waste toner collecting device is increased.

### CROSS-REFERENCE TO RELATED APPLICATIONS

This application claims the benefit of Korean Patent Application No. 2007-0011040, filed on Feb. 2, 2007 in the Korean Intellectual Property Office, the disclosure of which is incorporated herein by reference.

### BACKGROUND OF THE INVENTION

1. Field of the Invention

The present general inventive concept relates to an image forming apparatus, and more particularly to a waste toner collecting device of an electrophotographic image forming apparatus which forms a visible image using a toner and an image forming apparatus having the same.

2. Description of the Related Art

An image forming apparatus is an apparatus that prints a black and white image or a color image on a printing medium, e.g., paper, according to an inputted image signal, for example, a laser printer, an ink-jet printer, a copying machine, a multi-function printer, a fax machine, etc. An image forming apparatus is classified as an electrophotographic type in which a light beam is scanned onto a photosensitive body to form an electrostatic latent image and a toner is adhered to the electrostatic latent image to transfer the same onto a printing medium, or an ink-jet type in which a liquid type ink is ejected onto a surface of a printing medium according to an image signal.

Of them, the electrophotographic image forming apparatus is configured such that a surface of a photosensitive body is charged with a predetermined electric potential, a light beam is scanned onto the photosensitive body to form an electrostatic latent image due to electric potential difference, and a developer, i.e., a toner is adhered to the electrostatic latent image to form a visible image. The visible image formed on the photosensitive body is transferred onto the printing medium, and is fixed to the surface of the printing medium by applying heat and pressure to the printing medium.

Such an electrophotographic image forming apparatus is classified as a mono image forming apparatus which forms a visible image using a one color toner of black, or a color image forming apparatus which forms a color visible image by overlapping four color toners of yellow, magenta, cyan and black.

Most of the mono image forming apparatus adopts a direct transfer method by which the visible image formed on the surface of the photosensitive body is directly transferred onto the printing medium. The color image forming apparatus can adopt a direct transfer method by which the toners of the respective colors are directly transferred onto the printing medium, or an indirect transfer method by which the toners of the respective colors are overlapped in an intermediate transfer device and then transferred onto the printing medium.

The mono image forming apparatus and the color image forming apparatus commonly include a cleaning device to remove the residual toner on the photosensitive body or the intermediate transfer device without being transferred onto the printing medium, and a waste toner collecting device to collect the waste toner which drops from the photosensitive body or the intermediate transfer device by the cleaning device.

However, in the above conventional image forming apparatus, because the waste toner removed from the photosensitive body or the intermediate transfer device drops on a specific portion in the fixedly-mounted waste toner collecting device, the waste toner is concentratedly accumulated on the specific portion in the waste toner collecting device when used for a long time. Thus, the conventional image forming apparatus has problem that a collecting efficiency of the waste toner collecting device is deteriorated and the waste toner collecting device should be cleaned up or replaced frequently.

In order to solve this problem, an auger may be mounted to the waste toner collecting device so as to push the waste toner dropping from the photosensitive body or the intermediate transfer device into a waste toner container. In this waste toner collecting structure, the waste toner is accumulated in the waste toner container in a mountain shape. The waste toner accumulated in the mountain shape is dispersed by applying shock to the waste toner container by using a cover provided at a main body of the image forming apparatus. In other words, the shock generated due to collision of the cover and the waste toner container when opening or closing the cover disperses the waste toner evenly in the waste toner container.

However, the collision of the cover and the waste toner container may cause breakage of components, and an efficiency of flattening the waste toner which is accumulated in the mountain shape in the waste toner container by the external shock is no more than 60%. Thus, an increase in a waste toner collecting efficiency can be hardly anticipated.

### SUMMARY OF THE INVENTION

The present general inventive concept provides a waste toner collecting device and an image forming apparatus having the same in which a waste toner removed from a photosensitive body or an intermediate transfer device can be accumulated evenly in an overall waste toner collecting space without being concentrated on a specific portion, thereby increasing a waste toner collecting efficiency.

Additional aspects and/or advantages of the invention will be set forth in part in the description which follows and, in part, will be obvious from the description, or may be learned by practice of the invention.

The foregoing and other aspects and utilities of the present general inventive concept may be achieved by providing an image forming apparatus including a photosensitive body on which an electrostatic latent image is formed, a developing unit which adheres a toner to the photosensitive body to form a visible image, a transfer unit which transfers the visible image formed on the photosensitive body onto a printing medium, and a waste toner collecting device which collects waste toners removed from the photosensitive body and not being transferred onto the printing medium, the waste toner collecting device including a housing which has a collecting space to accommodate the waste toners, a waste toner distribution plate which is shakably mounted in the collecting space to receive the waste toners introduced into the collecting space and evenly disperse the waste toners in the collecting space, and a shaking device which shakes the waste toner distribution plate.

The waste toner distribution plate may be provided with a plurality of through-holes through which the waste toners pass.

The waste toner distribution plate may be reciprocatingly movably mounted to the housing, and the shaking device may include a pusher which pushes the waste toner distribution plate, and a return spring which returns the waste toner distribution plate moved by the pusher to an original position.

The pusher may include a cam member which contacts the waste toner distribution plate, and a motor which rotates the cam member.

The waste toner distribution plate may be provided with a guide slot, and the housing may have a supporting column which supports the waste toner distribution plate. The supporting column may be provided with a guide protrusion which is inserted through the guide slot.

The image forming apparatus may further include a cover which covers the housing. The cover may be provided with an inlet port through which the waste toners are introduced.

The image forming apparatus may further include a waste toner guide member which is mounted between the photosensitive body and the cover to guide the waste toners removed from the photosensitive body to the inlet port.

The photosensitive body and the developing unit may be provided in plural, the transfer unit may include an intermediate transfer device onto which visible images formed on the plural photosensitive bodies are transferred and overlapped, and the waste toners removed from the intermediate transfer device without being transferred onto the printing medium may be introduced into the housing of the waste toner collecting device.

The image forming apparatus may further include a waste toner sensor to detect an amount of waste toner accommodated in the waste toner collecting device.

The foregoing and other aspects and utilities of the present general inventive concept may also be achieved by providing a waste toner collecting device usable with an image forming apparatus, including a housing having a collecting space, and a waste toner distribution plate movably mounted in the housing to receive the waste toner thereon and to disperse the received waste toner into the collecting space.

The waste toner distribution plate may form the collection space with a bottom of the housing and another space with a top of the housing, and the received waste toner may be disposed on the waste toner distribution in the another space and moves to the collecting space by a movement of the waste toner distribution plate.

The waste toner distribution plate may include a surface on which the waste toner accumulates, and the waste toner accumulated on the surface may drop into the collecting space.

The waste toner distribution plate may include a surface on which a first portion of the waste toner accumulates, and a through hole through which a second portion of the waste toner passes toward the collecting space by its weight without accumulating on the surface.

The first portion of the toner may drop from the surface into the collecting surface according to a movement of the waste toner distribution plate.

The second portion of the toner may drop into the collecting surface without a movement of the waste toner distribution plate.

The waste toner distribution plate may be spaced from a top of the housing by a first distance to form a space to temporarily store a first portion of the toner, and may be spaced apart from a bottom of the housing by a second distance to form the collecting space to store the first portion of the toner and a second portion of the toner which is not temporarily stored in the space.

The housing may include a plurality of inlet ports to receive the waste toner, and the waste toner distribution plate may have an area corresponding to the inlet ports to receive the waste toner through the inlet ports.

The inlet ports may be spaced apart from each other by a distance, and the waste toner distribution plate may move by a second distance.

The foregoing and other aspects and utilities of the present general inventive concept may also be achieved by providing an image forming apparatus including an image forming unit to form an image with toner; and a waste toner collecting device disposed to receive waste toner from the image forming unit, and having a housing having a collecting space, and a waste toner distribution plate movably mounted in the housing to receive the waste toner thereon and to disperse the received waste toner into the collecting space.

### BRIEF DESCRIPTION OF THE DRAWINGS

These and/or other aspects and utilities of the exemplary embodiments of the general inventive concept will become apparent and more readily appreciated from the following description of the embodiments, taken in conjunction with the accompanying drawings, of which:

FIG. 1 is a side-sectional view schematically illustrating an image forming apparatus according to an embodiment of the present general inventive concept;

FIG. 2 is an exploded perspective view schematically illustrating a waste toner collecting device of the image forming apparatus of FIG. 1; and

FIGS. 3 and 4 are side-sectional views illustrating an operation of the waste toner collecting device of the image forming apparatus of FIG. 1.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

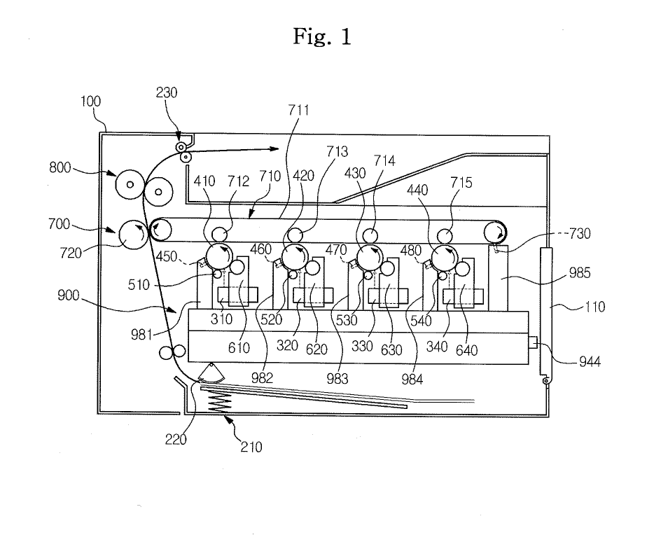

As illustrated in FIG. 1, an image forming apparatus according to an embodiment of the present general inventive concept includes a main body 100 which forms an external appearance, a service door 110 formed on a portion of the main body 100 to open and close the portion of the main body 100, a printing medium supply device 210 which supplies a printing medium, plural light scanning devices 310, 320, 330 and 340 which scan a beam, plural photosensitive bodies 410, 420, 430 and 440 on which electrostatic latent images are formed by receiving the beam, plural developing units 610, 620, 630 and 640 which form visible images by attaching toners to the respective photosensitive bodies 410, 420, 430 and 440, a transfer unit 700 which transfers the visible images onto the printing medium, a fixing unit 800 which fixes the visible images to the printing medium, a printing medium discharge device 230 which discharges the printing medium to the outside, and a waste toner collecting device 900 which collects a waste toner removed from the developing units 610, 620, 630 and 640 and an intermediate transfer device 710.

The photosensitive bodies 410, 420, 430 and 440 and developing units 610, 620, 630 and 640 may be referred to as an image forming unit to form a toner image to be transferred to a printing medium. The waste toner collecting device 900 may collect the waste toner from the image forming unit.

The respective developing units 610, 620, 630 and 640 store the toners of respectively different colors (e.g., yellow, magenta, cyan and black), and adhere the toners to the respective photosensitive bodies 410, 420, 430 and 440, on which the electrostatic latent images have been formed, to form the visible images of the respectively different colors.

The transfer unit 700 includes an intermediate transfer device 710 which overlaps the visible images formed on the respective photosensitive bodies 410, 420, 430 and 440 to form a color visible image, and a final transfer roller 720 which transfers the color visible image formed on the intermediate transfer device 710 onto the printing medium. The intermediate transfer device 710 includes a transfer belt 711 onto which the visible images formed on the respective photosensitive bodies 410, 420, 430 and 440 are transferred in order and overlapped, and plural intermediate transfer rollers 712, 713, 714 and 715 which transfer the visible images formed on the respective photosensitive bodies 410, 420, 430 and 440 onto the transfer belt 711.

If the printing operation is initiated, plural charge rollers 510, 520, 530 and 540, which are mounted near the photosensitive bodies 410, 420, 430 and 440, charge the surfaces of the photosensitive bodies 410, 420, 430 and 440 with a constant electric potential.

According to an image signal, the beams generated from the plural light scanning devices 310, 320, 330 and 340 are scanned onto the photosensitive bodies 410, 420, 430 and 440 to form the electrostatic latent images on the surfaces of the photosensitive bodies 410, 420, 430 and 440 by electric potential difference. The developing units 610, 620, 630 and 640 attach or supply the toners to the photosensitive bodies 410, 420, 430 and 440 to form the visible images of the respectively different colors on the photosensitive bodies 410, 420, 430 and 440. The visible images formed on the photosensitive bodies 410, 420, 430 and 440 are transferred in order onto the surface of the intermediate transfer belt 711 by the intermediate transfer rollers 712, 713, 714 and 715 and overlapped, so that the color visible image composed of the toner powders of four colors is formed on the intermediate transfer belt 711.

When the printing medium picked up from the printing medium supply device 210 by a pickup roller 220 is fed to the visible image transfer position between the intermediate transfer belt 711 and a final transfer roller 720, the color visible image formed on the intermediate transfer belt 711 is transferred onto the printing medium by the final transfer roller 720. The color visible image transferred onto the printing medium is fused to the surface of the printing medium by receiving heat and pressure while passing through the fixing unit 800. The printing medium having passed through the fixing unit 800 is discharged to the outside of the main body 100 by the printing medium discharge device 230.

Cleaning devices 450, 460, 470, 480 and 730 are mounted near the photosensitive bodies 410, 420, 430 and 440 and the intermediate transfer belt 711, so as to remove the residual toners which are not transferred from the photosensitive bodies 410, 420, 430 and 440 and the intermediate transfer belt 711. The waste toners removed by the cleaning devices 450, 460, 470, 480 and 730 are collected through waste toner guide members 981, 982, 983, 984 and 985 in the waste toner collecting device 900 which is mounted below the photosensitive bodies 410, 420, 430 and 440 and the intermediate transfer belt 711.

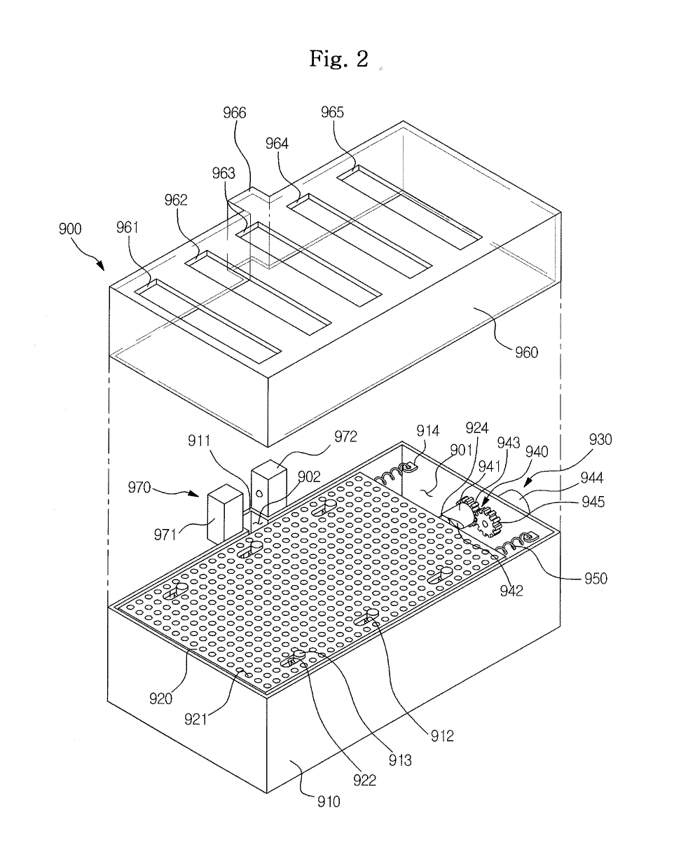

As illustrated in FIG. 2, the waste toner collecting device 900 includes a housing 910 which has a collecting space 901 to accommodate the waste toners, a waste toner distribution plate 920 which disperses the waste toners introduced into the collecting space 901 evenly over the whole collecting space 901, a shaking device 930 which shakes the waste toner distribution plate 920, and a cover 960 which covers the upper portion of the housing 910.

The housing 910 has a top-opened box shape, and is provided with a sensing portion 911 having a sensing space 902, which protrudes outward from one side portion of the housing 910. The waste toners introduced into the collecting space 901 of the housing 910 are also introduced into the sensing space 902. A waste toner sensor 970 (which will be described later) senses the waste toners accumulated in the sensing space 902 so that the amount of waste toner accumulated in the collecting space 901 can be detected. Plural supporting columns 912 are provided inside the housing 910 to support the waste toner distribution plate 920. Guide protrusions 913 are formed upward at the tops of the respective supporting columns 912. The guide protrusions 913 have a width smaller than the supporting columns 912.

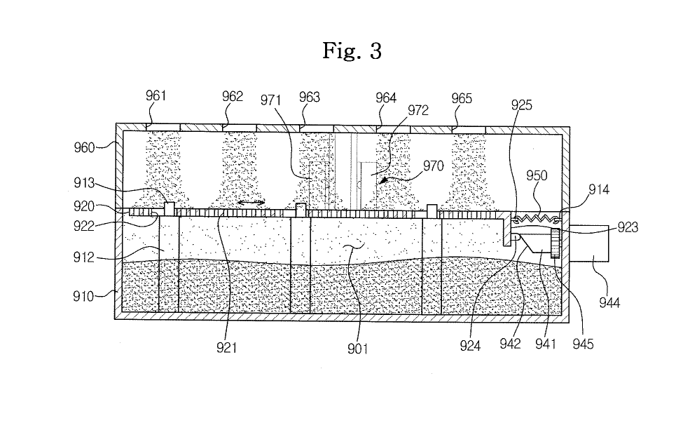

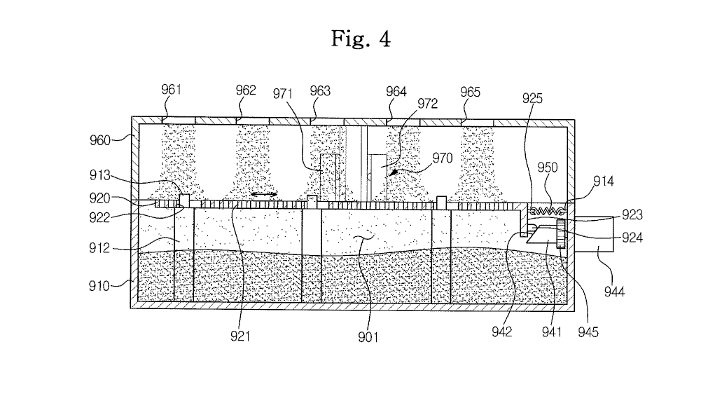

The waste toner distribution plate 920 is provided with a plurality of through-holes 921 through which the waste toners can pass, and is shakably mounted in the collecting space 901. The waste toner distribution plate 920 is further provided with plural guide slots 922 through which the guide protrusions 913 formed at the respective supporting columns 912 are inserted. A length of each of the guide slots 922 is longer than a distance by which the waste toner distribution plate 920 reciprocatingly moves by the shaking device 930. The waste toner distribution plate 920 can move reciprocatingly by the structure such that the guide protrusions 913 are inserted through the respective guide slots 922 and the lower surface of the waste toner distribution plate 920 is supported by the plural supporting columns 912. A supporting rib 923 (FIGS. 3 and 4) is provided at one side portion of the waste toner distribution plate 920, and an operating member 924 is protrudingly formed at the supporting rib 923.

The waste toner distribution plate 920 is not restricted to the above constitution. The waste toner distribution plate 920 can be modified into other constitutions, for example, such that it is shakably mounted in the collecting space without having through-holes and can disperse the waste toners introduced into the collecting space evenly in the collecting space.

The shaking device 930 includes a pusher 940 which pushes the waste toner distribution plate 920, and a pair of return springs 950 which return the waste toner distribution plate 920 moved by the pusher 940 to its original position. The pusher 940 includes a cam member 941 which contacts the operating member 924 of the waste toner distribution plate 920, and a motor 944 which rotates the cam member 941.

The cam member 941 is formed in a columnar or cylindrical shape which has a slanting surface 942 formed by cutting one end of the cam member 941 in a diagonal direction. By the slanting surface 942 contacting the operating member 924 of the waste toner distribution plate 920, the cam member 941 periodically presses the operating member 924 during the rotation. A supporting shaft (not shown) is protrudingly formed at the other end of the cam member 941. The supporting shaft is rotatably coupled to the housing 910 to support the cam member 941.

Also, the cam member 941 is provided with a gear 943 to be engaged with a driving gear 945 connected to the motor 944. If the motor 944 operates, the cam member 941 rotates in an opposite direction to a rotational direction of the driving gear 945. The motor 944 is mounted to the housing 910.

One end of each of the pair of return springs 950 is coupled to each of supporting brackets 914 provided at the housing 910, and the other end is coupled to each of supporting brackets 925 (see FIG. 3) provided at the supporting rib 923 of the waste toner distribution plate 920. The return springs 950 pull the waste toner distribution plate 920 toward the pusher 940 to return the waste toner distribution plate 920 moved by the pusher 940 to its original position. The number of the return springs 950 can be changed into one, or three or more.

The shaking device 930 is not restricted to the above constitution including the cam and the springs to rectilinearly and reciprocatingly move the waste toner distribution plate 920. The shaking device can be modified into other constitutions including, for example, a link mechanism, a linear motor or the like, that is capable of shaking the waste toner distribution plate 920 so as to evenly disperse the waste toners dropping on the waste toner distribution plate 920.

The cover 960 covering the opened top of the housing 910 is provided with plural waste toner inlet ports 961, 962, 963, 964 and 965 through which the waste toners are introduced into the cover 960. The cover 960 is further provided with a sensing portion 966 corresponding to the sensing portion 911 of the housing 910. When the cover 960 is coupled to the housing 910, the sensing space 902 is defined by the sensing portions 911 and 966.

The waste toner sensor 970 is mounted to the exterior of the sensing space 902. The waste toner sensor 970 senses the waste toners accumulated in the sensing space 902, so as to detect the point of timing when the amount of waste toner accumulated in the collecting space 901 reaches to the maximum amount. The cover 960 is made of a transparent material. The waste toner sensor 970 includes a light emitting element 971 and a light receiving element 972 which are disposed opposite to each other while the sensing portion 966 of the cover 960 is interposed therebetween, so as to detect the amount of waste toner accumulated in the collecting space 901 and the sensing space 902. In other words, if the waste toners introduced into the collecting space 901 and the sensing space 902 are accumulated to a level corresponding to the mounting position of the light emitting part 971 and the light receiving part 972, the light irradiated from the light emitting part 971 cannot be transmitted to the light receiving part 972 due to being interrupted by the waste toners, thereby a waste toner sensing signal is generated. The waste toner sensor 970 may be mounted to the main body 100 of the image forming apparatus or the waste toner collecting device 900.

As illustrated in FIG. 1, the waste toner guide members 981, 982, 983, 984 and 985 are mounted between the cover 960 and the photosensitive bodies 410, 420, 430 and 440 and between the cover 960 and the intermediate transfer belt 711. The lower ends of the waste toner guide members 981, 982, 983, 984 and 985 are coupled to the waste toner inlet ports 961, 962, 963, 964 and 965 of the cover 960. Accordingly, the waste toners removed from the photosensitive bodies 410, 420, 430 and 440 and the intermediate transfer belt 711 by the cleaning devices 450, 460, 470, 480 and 730 are guided by the waste toner guide members 981, 982, 983, 984 and 985, and introduced into the collecting space 901 through the waste toner inlet ports 961, 962, 963, 964 and 965.

When the toner is guided into the waste toner collecting device 900, a first portion of the toner may accumulate on the waste toner distribution plate 920, and a second portion of the toner may fall into a collecting space formed between the waste toner distribution plate 920 and a bottom of a body of the waste toner collecting device 900 to accumulate on the bottom of the body of the waste toner collecting device 900. The waste toner distribution plate 920 is spaced-apart from the bottom of the body of the waste toner collecting device 900 by a first distance to form the collecting space, and is spaced-apart from a cover, for example, a top of the body formed with the inlet parts 961, 962, 963, 964, and 965, by a second distance to form a second collecting space. The second portion of the toner passes from the inlet part 961, 962, 963, 964, and 965 through the through holes 921 toward the bottom of the body by its own weight. The first portion of the toner accumulates on a portion of the waste toner distribution plate 920 and then falls into the bottom of the body through the through holes 921 according to a movement of the waste toner distribution plate 920.

The inlet ports 961, 962, 963, and 964 are spaced apart form each other by a distance, and the waste toner distribution plate 920 moves by a second distance. The second distance may be shorter than the first distance. It is possible that the second distance may not be shorter than the first distance.

Hereinafter, an operation of the waste toner collecting device 900 of the image forming apparatus according to the present general inventive concept will be described.

As illustrated in FIG. 1, when the printing operation is performed, the toners are attached to the surfaces of the photosensitive bodies 410, 420, 430 and 440 to form the visible images. The visible images of four colors formed on the photosensitive bodies 410, 420, 430 and 440 are transferred onto the intermediate transfer belt 711 and overlapped to form the color visible image. In this process, the residual toners remaining on the photosensitive bodies 410, 420, 430 and 440 and/or not being transferred onto the intermediate transfer belt 711 are removed by the respective cleaning devices 450, 460, 470 and 480, and guided to the waste toner inlet ports 961, 962, 963 and 964 of the waste toner collecting device 900 by the respective waste toner guide members 981, 982, 983 and 984. Also, the residual toners on the intermediate transfer belt 711 without being transferred onto the printing medium are removed by the cleaning device 730, and guided to the waste toner inlet port 965 of the cover 960 by the waste toner guide member 985.

As illustrated in FIG. 3, the waste toners guided to the waste toner collecting device 900 by the waste toner guide members 981, 982, 983, 984 and 985 drop on the waste toner distribution plate 920 mounted in the collecting space 901 through the waste toner inlet ports 961, 962, 963, 964 and 965. While the waste toners drop, the motor 944 operates, and accordingly the cam member 941 rotates to press periodically the operating member 924 of the waste toner distribution plate 920. If the operating member 924 is pressed by the cam member 941, the pair of return springs 950 coupled to the waste toner distribution plate 920 extend, and the waste toner distribution plate 920 moves to the left on the drawing while being supported by the supporting columns 912. At this time, the guide protrusions 913 inserted through the guide slots 922 of the waste toner distribution plate 920 guide the rectilinear movement of the waste toner distribution plate 920. Subsequently, if the cam member 941 further rotates to the state as depicted in FIG. 4, the waste toner distribution plate 920 moves to the right on the drawing by the elastic restoring force of the pair of return springs 950.

Since the waste toner distribution plate 920 is shaken by rectilinearly and/or reciprocatingly moving by the cam member 941 and the return springs 950, the waste toners dropping on the waste toner distribution plate 920 through the waste toner inlet ports 961, 962, 963, 964 and 965 are dispersed evenly on the upper surface of the waste toner distribution plate 920, and then introduced evenly into the collecting space 901 through the plurality of through-holes 921.

If the waste toners introduced into the collecting space 901 and the sensing space 902 are accumulated to the level corresponding to the mounting position of the light emitting part 971 and the light receiving part 972 of the waste toner sensor 970, the waste toner sensor 970 detects the accumulated amount of waste toner, and indicates the detecting result through an indicating lamp or a display part. In this case, a user opens the service door 110 (see FIG. 1) provided at the main body 100, and dismantles the waste toner collecting device 900 from the main body 100 to empty the collecting space 901 or replacing the waste toner collecting device with a new one.

As apparent from the above description, the image forming apparatus according to the present embodiment is constituted such that the waste toners removed from the photosensitive bodies or the intermediate transfer belt and dropping into the collecting space are evenly dispersed by the waste toner distribution plate. Accordingly, the waste toners are not concentrated on a specific portion in the collecting space, and are evenly accumulated in the overall collecting space. As a result, a waste toner collecting efficiency of the waste toner collecting device is increased, and a cleaning cycle of the waste toner collecting device can be extended.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. An image forming apparatus comprising:
a photosensitive body on which an electrostatic latent image is formed;
a developing unit which attaches a toner to the photosensitive body to form a visible image;
a transfer unit which transfers the visible image formed on the photosensitive body onto a printing medium; and
a waste toner collecting device which collects waste toners removed from the photosensitive body and not being transferred onto the printing medium, the waste toner collecting device including a housing which has a collecting space to accommodate the waste toners, a waste toner distribution plate which is shakably mounted in the collecting space to receive the waste toners introduced into the collecting space and evenly disperse the waste toners in the collecting space, and a shaking device which shakes the waste toner distribution plate.

2. The image forming apparatus according to claim 1, wherein the waste toner distribution plate is provided with a plurality of through-holes through which the waste toners pass.

3. The image forming apparatus according to claim 1, wherein the waste toner distribution plate is reciprocatingly movably mounted to the housing, and
the shaking device includes a pusher which pushes the waste toner distribution plate, and a return spring which returns the waste toner distribution plate moved by the pusher to an original position.

4. The image forming apparatus according to claim 3, wherein the pusher includes a cam member which contacts the waste toner distribution plate, and a motor which rotates the cam member.

5. The image forming apparatus according to claim 3, wherein the waste toner distribution plate is provided with a guide slot, and
the housing has a supporting column which supports the waste toner distribution plate, the supporting column being provided with a guide protrusion which is inserted through the guide slot.

6. The image forming apparatus according to claim 1, further comprising:
a cover which covers the housing, the cover being provided with an inlet port through which the waste toners are introduced.

7. The image forming apparatus according to claim 6, further comprising:
a waste toner guide member which is mounted between the photosensitive body and the cover to guide the waste toners removed from the photosensitive body to the inlet port.

8. The image forming apparatus according to claim 1, wherein the photosensitive body and the developing unit are provided in plural,
the transfer unit includes an intermediate transfer device onto which visible images formed on the plural photosensitive bodies are transferred and overlapped, and
the waste toners removed from the intermediate transfer device without being transferred onto the printing medium are introduced into the housing of the waste toner collecting device.

9. The image forming apparatus according to claim 1, further comprising:
a waste toner sensor to detect an amount of waste toner accommodated in the waste toner collecting device.

10. A waste toner collecting device of an image forming apparatus, comprising:
a housing which has a collecting space to accommodate waste toners;
a waste toner distribution plate which is shakably mounted in the collecting space to receive the waste toners introduced into the collecting space and evenly disperse the waste toners on an upper surface of the waste toner distribution plate; and
a shaking device which shakes the waste toner distribution plate.

11. The waste toner collecting device according to claim 10, wherein the waste toner distribution plate is provided with a plurality of through-holes through which the waste toners put on the upper surface of the waste toner distribution plate pass.

12. The waste toner collecting device according to claim 10, wherein:
the waste toner distribution plate is reciprocatingly movably supported by the housing; and
the shaking device includes a pusher which pushes the waste toner distribution plate, and a return spring which returns the waste toner distribution plate moved by the pusher to an original position.

13. The waste toner collecting device according to claim 12, wherein the pusher includes a cam member which contacts the waste toner distribution plate, and a motor which rotates the cam member.

14. The waste toner collecting device according to claim 12, wherein:
the waste toner distribution plate is provided with a guide slot; and
the housing has a supporting column which supports the waste toner distribution plate, the supporting column being provided with a guide protrusion which is inserted through the guide slot.

15. The waste toner collecting device according to claim 10, further comprising:
a cover which covers the housing, the cover being provided with an inlet port through which the waste toners are introduced.

16. A waste toner collecting device usable with an image forming apparatus, comprising:
a housing having a collecting space; and
a waste toner distribution plate movably mounted in the housing to receive the waste toner thereon and to disperse the received waste toner into the collecting space.

17. The waste toner collecting device according to claim 16, wherein:
the waste toner distribution plate forms the collection space with a bottom of the housing and another space with a top of the housing; and
the received waste toner is disposed on the waste toner distribution in the another space and moves to the collecting space by a movement of the waste toner distribution plate.

18. The waste toner collecting device according to claim 16, wherein:
the waste toner distribution plate comprises a surface on which a first portion of the waste toner accumulates, and a through hole through which a second portion of the waste toner passes toward the collecting space by its weight without accumulating on the surface.

19. The waste toner collecting device according to claim 16, wherein the waste toner distribution plate is spaced from a top of the housing by a first distance to form a space to temporarily store a first portion of the toner and is spaced apart from a bottom of the housing by a second distance to form the collecting space to store the first portion of the toner and a second portion of the toner which is not temporarily stored in the space.

20. The waste toner collecting device according to claim 16, wherein:
the housing comprises a plurality of inlet ports to receive the waste toner; and
the waste toner distribution plate has an area corresponding to the inlet ports to receive the waste toner through the inlet ports.
